(19) United States
(12) Patent Application Publication
(10) Pub. No.: US 2007/0126740 A1
(43) Pub. Date: Jun. 7, 2007

(54) Apparatus and method for creating animation

(75) Inventor: Norio Nomura, Kanagawa (JP)

Correspondence Address: STEVENS, DAVIS, MILLER & MOSHER, LLP, 1615 L. STREET N.W., SUITE 850, WASHINGTON, DC, 20036, US

(73) Assignee: Matsushita Electric Industrial Co., Ltd., Osaka (JP)

(21) Appl. No.: 10/575,617

(22) PCT Filed: Oct. 6, 2004
(86) PCT No.: PCT/JP04/14751

§ 371 Date: Apr. 13, 2006

(30) Foreign Application Priority Data
Oct. 15, 2003 (JP) 2003-0354868

(51) Int. Cl. G06T 15/70

(52) U.S. Cl. 345/473

(57) ABSTRACT

An animation creating apparatus that realizes more expressive “talking animation” by simplifying interface functions of a voiced/silent decision section and animation creating section and providing these sections in independent configurations, and that flexibly support various animation creating schemes and enable portable terminals to have lip-sync animation creating functions. In this apparatus, voiced/silent decision section 102 outputs degrees of voicedness of input speech signal (called “degree of voicedness”) and outputs them to animation creating section 103. Animation creating section 103 stores three images of a closed mouth, half-opened mouth and opened mouth, selects corresponding images from the three images by deciding the degree of voicedness input from voiced/silent decision section 102 with decision criteria in 3 stages of L, M, S, and performing a state transition, creates “talking animation” and outputs it to display section 104.

### TECHNICAL FIELD

The present invention relates to an animation creating apparatus and animation creating method for creating lip-sync animation.

### BACKGROUND ART

Cellular phones in recent years have various functions such as camera functions and there is a demand for the realization of interface functions to improve the convenience of these functions. As an example of such an interface technology, there is a proposal of a function where an animated image talks according to a speech signal, and hereinafter this function will be referred to as “lip-sync.”

FIG. 1 illustrates a configuration example of animation creating apparatus 500 that realizes conventional lip-sync functions, which is configured with microphone 501, voiced/silent decision section 502, animation creating section 503 and display section 504.

A speech signal input from microphone 501 is input to voiced/silent decision section 502. Voiced/silent decision section 502 extracts information about the power of speech or the like from the speech signal input from microphone 501, makes a binary decision as to whether the input speech is voiced or silent and outputs decision information to animation creating section 503.

Animation creating section 503 creates “talking animation” using the binary voiced/silent decision information input from voiced/silent decision section 502. Animation creating section 503 prestores several images of, for example, a closed mouth, half-opened mouth and fully opened mouth or the like and creates “talking animation ” by selecting from these images using the binary voiced/silent decision information.

This image selection process can be performed using the state transition diagram shown in FIG.2. In this case, V/S denotes the decision result of voiced/silent decision section 502, where V is a voiced decision and S is a silent decision. In this FIG.2, animation creating section 503 creates lip-sync animation by selecting an “opened mouth” image when the decision result makes a S→V transition, and next selecting a “half-opened mouth” image regardless of the decision result and further selecting a “closed mouth” image when the decision result makes a transition from this state to S. Display section 504 displays the lip-sync animation created by animation creating section 503.

Furthermore, there is an apparatus which creates a conventional lip-sync animation as described in Patent Document 1. This apparatus stores first shape data about the shape of the mouth when pronouncing a vowel by types of vowel, classifies consonant types having a common mouth shape when pronouncing into the same group, stores second shape data about the shape of the mouth when pronouncing consonants classified into this group by the group, divides sound of a word by each vowel or consonant, controls the operation of a facial image by each divided vowel or consonant based on the first shape data corresponding to vowels or the second shape data corresponding to the group where consonants are classified.

Patent Document 1: Unexamined Japanese Patent Publication No. 2003-58908

### DISCLOSURE OF INVENTION

Problems to be Solved by the Invention

In the animation creating apparatus which realizes conventional lip-sync functions, the voiced/silent decision section that decides whether speech is voiced or silent, outputs only a binary decision result, and so there is a problem that the animation creating section can only create monotonous, unexpressive animation such that the mouth moves mechanically during the voiced period.

Furthermore, it is necessary to change and make the configurations of interfaces for the voiced/silent decision section and animation creating section more complicated to realize more expressive “talking animation” , and necessary to prepare an animation creating section that is compatible with various animation creating schemes and also change the voiced/silent decision section respectively for each scheme, which results in a problem of increased apparatus cost. That is, it is difficult to configure the voiced/silent decision section and animation creating section independently and difficult to realize flexible configurations.

Furthermore, the apparatus of Patent Document 1 stores first shape data about the shape of the mouth when pronouncing a vowel and second shape data about the shape of the mouth when pronouncing a consonant, divides the sound of a word by each vowel or consonant and controls the operation of the facial image based on the first shape data or second shape data for each divided vowel or consonant, and therefore there is a problem that the amount of data to be stored increases and the control contents become complex. Furthermore, it increases load on the configuration and control to have functions of the above configurations on portable devices such cellular phones and portable information terminals, and so it is not realistic.

It is therefore an object of the present invention to provide an animation creating apparatus and animation creating method that realize more expressive “talking animation” by simplifying interface functions for a voiced/silent decision section and animation creating section and providing these sections in independent configurations, and that flexibly support various animation creating schemes and enable portable terminals to have lip-sync animation creating functions.

Means for Solving the Problem

The animation creating apparatus of the present invention adopts a configuration having a voiced/silent decision section that decides whether speech is voiced or silent and outputs a decision result in continuous values indicating degrees of voicedness, and an animation creating section that creates lip-sync animation using the decision result output from the voiced/silent decision section.

Advantageous Effect of the Invention

According to the present invention, it is possible to realize more expressive “talking animation” by simplifying interface functions of a voiced/silent decision section and animation creating section and providing these sections in independent configurations, flexibly support various animation creating schemes and have lip-sync animation creating functions on portable terminals.

### BRIEF DESCRIPTION OF DRAWINGS

FIG. 1 is a block diagram showing the configuration of a conventional animation creating apparatus;

FIG. 2 illustrates an example of a transition state of image selection of the animation creating apparatus in FIG. 1;

FIG. 3 is a block diagram showing the configuration of an animation creating apparatus according to an embodiment of the present invention;

FIG. 4A illustrates an example of a simulation result of a voiced/silent decision by the voiced/silent decision section of the animation creating apparatus according to this embodiment;

FIG. 4B illustrates an example of a simulation result of a voiced/silent decision in the voiced/silent decision section of the animation creating apparatus according to this embodiment; and

FIG. 5 illustrates an example of a transition state of image selection by the animation creating section of the animation creating apparatus according to this embodiment.

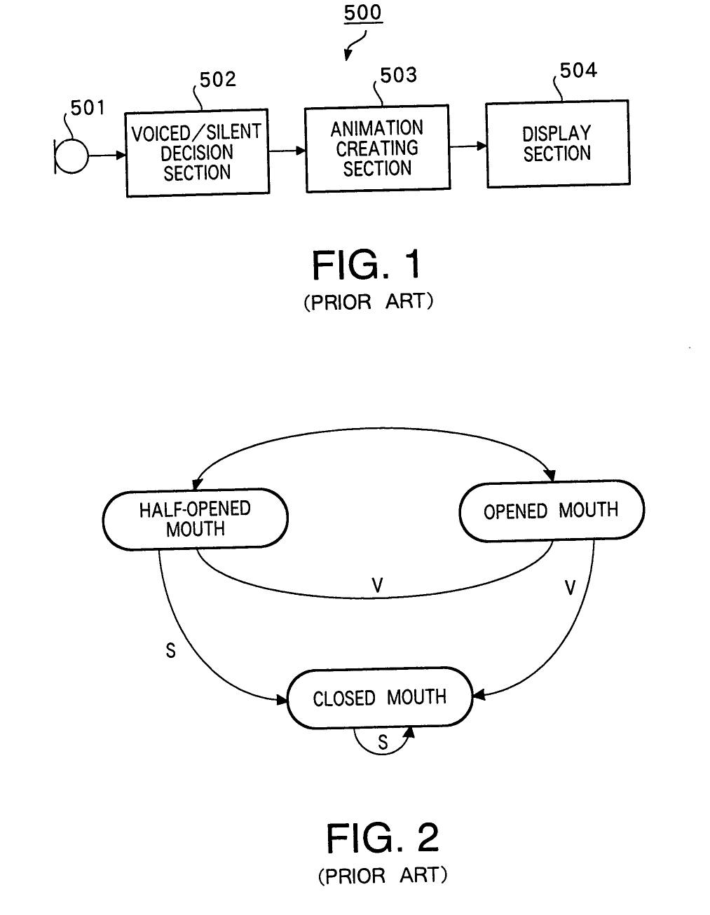

### BEST MODE FOR CARRYING OUT THE INVENTION

Now, an embodiment of the present invention will be described in detail with reference to the accompanying drawings.

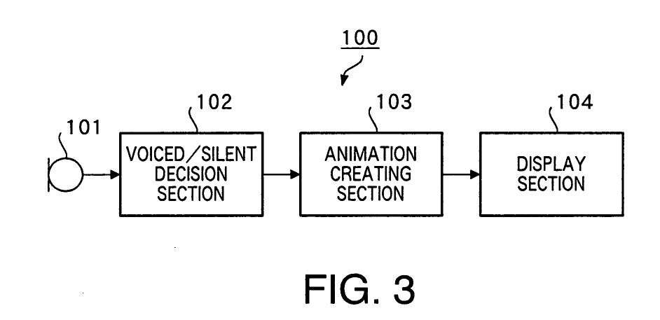

FIG. 3 is a block diagram showing essential components of animation creating apparatus 100 according to an embodiment of the present invention. Animation creating apparatus 100 is configured with microphone 101, voiced/silent decision section 102, animation creating section 103 and display section 104.

Microphone 101 converts input speech into a speech signal and outputs the speech signal to voiced/silent decision section 102. Voiced/silent decision section 102 extracts information about power or the like of speech from the speech signal input from microphone 101, decides whether input speech is voiced or silent and outputs degrees of voicedness in continuous values between 0 and 1 to animation creating section 103.

Here, the degree of voicedness is output as “1.0: likely voiced, 0.5: unknown, 0.0: likely silent.” For this voiced/silent decision section 102, the voiced decision function described in Unexamined Japanese Patent Publication No. HEI 05-224686, filed earlier by the present applicant, can be used. This application is designed to make an inference using a multivalue logic having values in the range of 0 to 1 in a decision process and using values defined as 0: “silent”, 0.5: “impossible to estimate”, 1: “voiced” and make a binary decision on whether speech is voiced or silent in the final stage. The present invention is configured such that the value before final binarization in the voiced/silent decision in the present invention as the degree of voicedness.

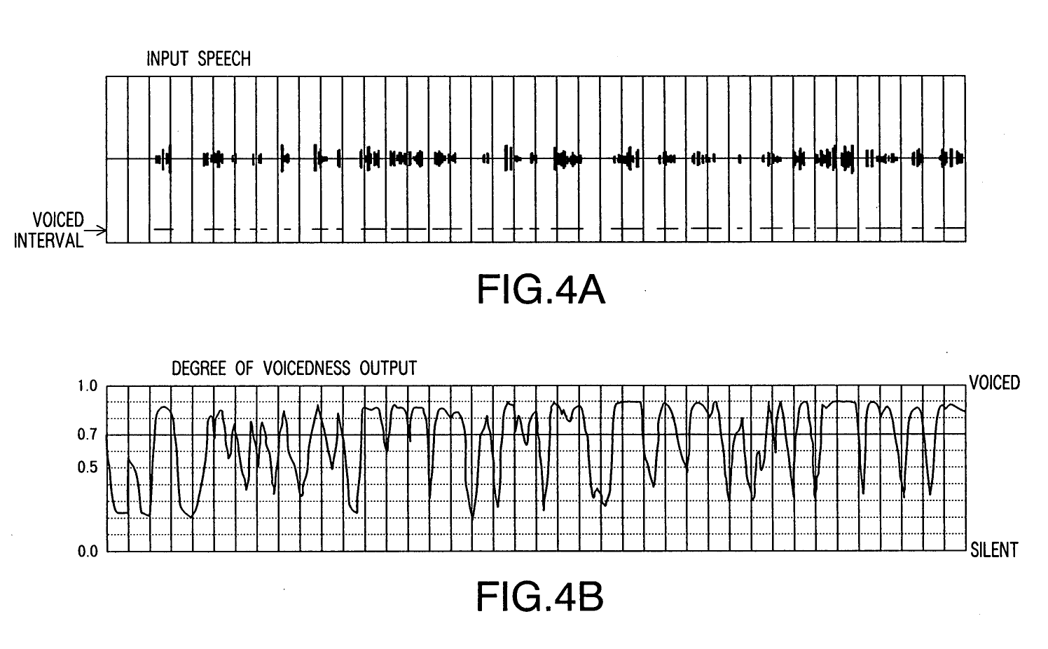

FIG. 4A and FIG. 4B show simulation results of voiced/silent decision section 102 created based on the decision method described in Unexamined Japanese Patent Publication No. HEI 05-224686. The horizontal line marked “voiced interval” below the waveform of input speech of FIG. 4A indicates an interval of degree of voicedness>0.7 shown in FIG. 4B. According to the conventional voiced/silent decision scheme, a binary decision result is output to animation creating section 103 as a result of such a decision of “voiced interval” and “silent interval.”

Voiced/silent decision section 102 of this embodiment outputs the degree of voicedness to animation creating section 103 in contrast to the binary decision according to this conventional scheme.

Animation creating section 103 decides the degree of voicedness input from voiced/silent decision section 102 based on three-stage criteria “L: 0.9≦degree of voicedness≦1.0, M: 0.7≦degree of voicedness <0.9, S: 0.0≦degree of voicedness <0.7”, selects a corresponding image from three images of a closed mouth, half-opened mouth and opened mouth based on these decision results L, M, S, creates “talking animation” and outputs it to display section 104.

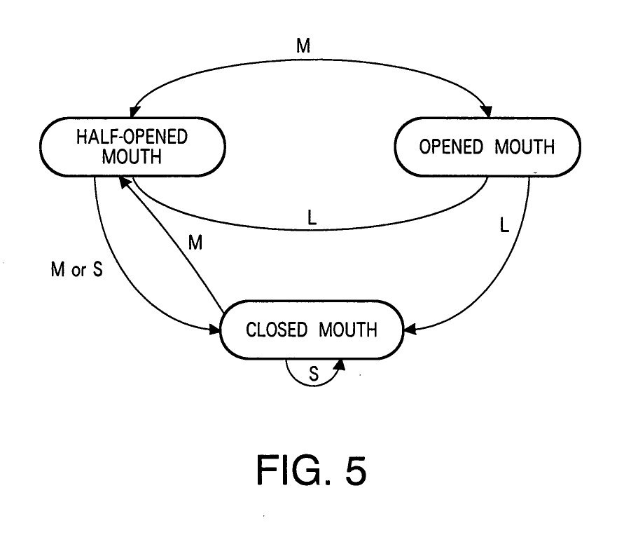

FIG. 5 shows a state transition of image selection executed by animation creating section 103. Animation creating section 103 selects the “closed mouth” image when the degree of voicedness from voiced/silent decision section 102 is decided to be S, selects the “half-opened mouth” image when the degree of voicedness is decided to be M and selects the “opened mouth” image when the degree of voicedness is decided to be L. In such a case, the transition state of the image becomes “closed mouth” →“half-opened mouth”→“opened mouth” and an animation of a mouth that gradually opens is displayed on display section 104.

Furthermore, when the degree of voicedness from voiced/silent decision section 102 is decided to be M or S with the “half-opened mouth” image selected, animation creating section 103 selects the “closed mouth” image and thereby allows a transition from “half-opened mouth”→“closed mouth,” enabling a finer animation display than the conventional art. Display section 104 displays finer and more expressive animation than the conventional art by displaying selected images sequentially input from animation creating section 103.

Although a case has been described with the example of FIG. 5 where image selection is controlled so that the number of images is three and the degree of voicedness is classified into three stages, it is possible to change the number of images, the number of classification stages of the degree of voicedness and control method. Furthermore, it is also possible not to classify the degree of voicedness in this way and instead directly process the value of the degree of voicedness and create an image. Therefore, animation creating apparatus 100 of this embodiment can use similar interface functions based on the degree of voicedness and degree of voicedness decision section for various animation creating methods.

As shown above, according to the animation creating apparatus of this embodiment, the animation creating section can perform finer image selection control than the conventional art by using unbinarized degree of voicedness and create more expressive “talking animation.” Furthermore, the number of images or the like processed by the animation creating section can also be flexible, and even when the animation creating method is different, it is not necessary to change interface functions based on the degree of voicedness between the voiced/silent decision section and the animation creating section, thereby making it possible to simplify the interface functions. That is, it is possible to provide the voiced/silent decision section and animation creating section in independent configurations and adopt flexible configurations for various animation creating methods. Therefore, the animation creating apparatus of this embodiment is flexibly compatible with various animation creating methods, can simplify the configuration, can also reduce load of the animation creating processing, and can thereby be easily mounted on portable terminals.

Although a case has been described with the above embodiment where a microphone is used to input a speech signal to the voiced/silent decision section, it is also possible to input speech from a communicating party in a conversation using cellular phones or a reproduced signal of a stored speech signal. Furthermore, although the display section is configured inside the subject apparatus, it is also possible to transfer created animation to the display section of a communicating party or output it to the display section of personal computers or the like.

A first aspect of the animation creating apparatus of the present invention adopts a configuration having a voiced/silent decision section that decides whether speech is voiced or silent and outputs a decision result in continuous values indicating degrees of voicedness, and an animation creating section that creates lip-sync animation using the decision result output from the voiced/silent decision section.

According to this configuration, it is possible to realize more expressive “talking animation” by simplifying interface functions of the voiced/silent decision section and animation creating section and providing these sections in independent configurations, flexibly support various animation creating schemes, and have lip-sync animation creating functions on portable terminals.

A second aspect of the animation creating apparatus of the present invention adopts a configuration of the animation creating apparatus according to the first aspect, and in this apparatus the voiced/silent decision section outputs continuous values (called “degree of voicedness”) indicating the degrees of voicedness.

According to this configuration, it is possible to reduce load of animation creating processing by the animation creating section and make it easy to have lip-sync animation creating functions on portable terminals.

A third aspect of the animation creating apparatus of the present invention adopts a configuration of the animation creating apparatus according to the first aspect, and in this apparatus the animation creating section sequentially selects corresponding images from a plurality of prestored images using the voiced/silent decision result output from the voiced/silent decision section and creates lip-sync animation.

According to this configuration, it is also possible to provide flexibility for the number of images processed by the animation creating section.

A first aspect of the animation creating method of the present invention has a voiced/silent decision step of deciding whether speech is voiced or silent and outputting a decision result in continuous values indicating degrees of voicedness, and an animation creating step of creating lip-sync animation using the voiced decision result output from the voiced/silent decision.

According to this method, it is possible to realize more expressive “talking animation” by simplifying the interface functions of the voiced/silent decision section and animation creating section and providing these sections in independent configurations, flexibly support various animation creating schemes, and have lip-sync animation creating functions on portable terminals.

The present application is based on Japanese Patent Application No. 2003-354868 filed on Oct. 15, 2003, entire content of which is expressly incorporated by reference herein.

### IDUSTRIAL APPLICABILITY

The present invention realizes lip-sync animation creating functions which can be had on portable terminals or the like using animation creating apparatus.

1. An animation creating apparatus comprising:
a voiced/silent decision section that decides whether speech is voiced or silent and outputs a decision result in continuous values indicating degrees of voicedness; and
an animation creating section that creates lip-sync animation using the voiced decision result output from said voiced/silent decision section.

2. The animation creating apparatus according to claim 1, wherein said voiced/silent decision section outputs continuous values indicating said degrees of voicedness.

3. The animation creating apparatus according to claim 1, wherein said animation creating section sequentially selects corresponding images from a plurality of prestored images using the voiced/silent decision result output from said voiced/silent decision section and creates lip-sync animation.

4. An animation creating method comprising:
a voiced/silent decision step of deciding whether speech is voiced or silent and outputting a decision result in continuous values indicating degrees of voicedness; and
an animation creating step of creating lip-sync animation using the voiced decision result output from said voiced/silent decision step.
